(19) United States
(12) Patent Application Publication
(10) Pub. No.: US 2010/0282032 A1
(43) Pub. Date: Nov. 11, 2010

(54) SELF-ADJUSTING PLIERS

(75) Inventor: Michael Brailey, Munich (DE)

Correspondence Address: PEARNE & GORDON LLP, 1801 EAST 9TH STREET, SUITE 1200, CLEVELAND, OH, 44114-3108, US

(73) Assignee: Wendeng Maxpower Tool Group Co. Ltd., Wendeng (CN)

(21) Appl. No.: 12/680,983

(22) PCT Filed: Oct. 1, 2008
(86) PCT No.: PCT/GB08/03313

§ 371 Date: Jul. 22, 2010

(30) Foreign Application Priority Data
Oct. 1, 2007 (GB) 0719148.9

(51) Int. Cl. B25B 7/04

(52) U.S. Cl. 81/385; 81/407

(57) ABSTRACT

The application relates to a pair of pliers (1). More specifically the application describes a pair of single-handed automatically self-adjusting water-pump pliers for clamping or gripping a workpiece. The pair of pliers comprises a first and a second handle (2,3), each handle comprising a jaw portion (8,9), a neck portion (6,7) and a handle portion (4,5), a spacing means (10) between the handle portions (4,5) for adjusting the opening width of the jaw portion (8,9); and the two handles (2,3) are pivotably and slidably connected to each other by means of releasable locking means (13).

The present invention relates to a pair of pliers. In particular, the invention relates to a pair of single-handed automatically self-adjusting water-pump pliers.

A pair of water pump pliers is generally understood to be a pair of pliers with a first and second leg, each having a handle portion and a jaw portion and which are interconnected between the handle portion and the jaw portion by means of a joint. The joint is guided in a longitudinal aperture of the first leg and the aperture is provided with detents. By adjusting the joint in the longitudinal aperture, the opening width of the pliers, i.e. the spacing of the pliers jaw, can be varied. By such an arrangement, it is possible to adapt the opening width to the dimension of the part to be gripped and to grasp parts of considerably different diameters in the same way.

However, one disadvantage of known water pump pliers is that, in order to adjust the opening width of the jaws, the user must inevitably use both his hands to position the joint in the longitudinal aperture. Therefore, known pliers are unpractical since the user cannot alone hold the workpiece to be clamped between the jaws of the pliers and adjust the opening width of the jaws to clamp the workpiece.

According to a first aspect of the invention there is provided a self-adjusting pair of pliers for clamping a workpiece comprising a first and a second handle, each handle comprising a jaw portion, a neck portion and a handle portion, a spacing means between the handle portions for adjusting the opening width of the jaw portions; and wherein the two handles are pivotably and slidably connected to each other by means of releasable locking means.

The spacing means has a first and a second end and the first end may be attached to the handle portion of the first handle. When pressure is applied on the handle portion of the second handle, the second handle slides over the second end of the spacing means so that the opening width of the jaws decreases.

The spacing means may comprise a spring means, for example a helical spring. Alternatively, the spacing means may be rigid.

The releasable locking means can comprise a longitudinal aperture on the neck portion of the first handle and a pawl pivotably connected to the neck portion of the second handle. The longitudinal aperture can comprise a plurality of notches and the pawl can comprise at least one tooth that is engageable to a notch. The pawl can be slidably movable along the aperture.

The pliers of the invention can further comprise biasing means connected to the neck portion of the second handle and the biasing means exerts pressure onto the pawl so that the tooth engages with a notch in the aperture.

The pliers of the invention can further comprise a release pin for releasing the tooth from the notch.

The jaw portions can comprise substantially parallel gripping surfaces. Furthermore, at least one jaw portion can comprise a dented surface for gripping the workpiece.

Thus, the invention seeks to provide a pair of pliers, more particularly a pair of water pump pliers, that can be used with one hand. In addition, the jaws opening width of the pliers according to the invention can automatically self-adjust to the size of a workpiece to be gripped or clamped.

The invention will be further described with reference to the drawings and figures, in which:

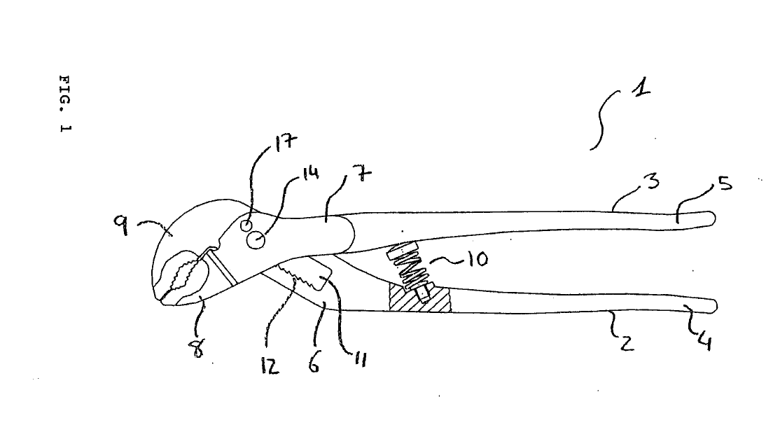

FIG. 1 shows an example of a pair of pliers according to the invention;

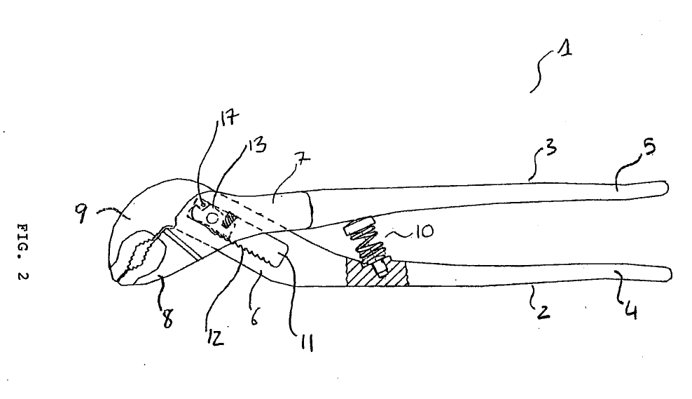

FIG. 2 shows the inner mechanism of a pair of pliers as shown in FIG. 1; and

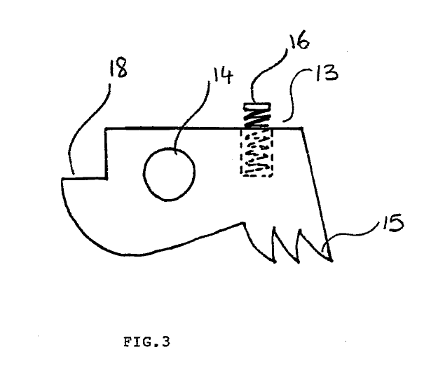

FIG. 3 shows an example of pawl used in a pair of pliers according to the invention.

Referring to FIGS. 1 and 2, there is illustrated a pair of pliers 1 according to the invention comprising a first handle 2 and a second handle 3. Each handle comprises a handle portion 4, 5, a neck portion 6,7 and a jaw portion 8, 9. The pliers 1 further comprise spacing means 10 located between the handle portions 4, 5.

In the embodiment shown in FIG. 1, the spacing means 10 comprises a helical spring and although this type of spring is preferred, the spacing means can also be a different type of spring. Alternatively, the spacing means can be rigid. The spacing means 10 comprises a first and a second end. Preferably, the first end is connected to the handle portion 4 of the first handle 2 and the second end abuts the handle portion 5 of the second handle 3.

The first handle 2 has a longitudinal aperture 11 in its neck portion 6. The aperture 11 comprises a toothed ratchet with a plurality of notches 12 on at least one of its sidewalls. A pawl 13 is pivotably connected to the neck portion 7 of the second handle 3 by means of, for example, a pivot pin 14.

As can be seen in FIG. 3, the pawl 13 comprises at least one tooth 15 that is engageable to the notches 12 in the aperture 11. The tooth 15 is preferably triangular, but any shape suitable for engaging the notches 12 can be used. Preferably, the shape of the pawl 13 is such the pawl 13 fits within the aperture 11. For example, the pawl thickness is preferably equal or smaller than the depth of the aperture 11.

A spring means 16 is arranged between the pawl 13 and a sidewall of the aperture 11, so that pressure is exerted onto the tooth 15 to engage with one of the notches 12.

The pair of pliers 1 may also comprise a release pin 17 connected to the neck portion 7 of the second handle 3 and extending at least partially through the aperture 11. The release pin 17 abuts a release surface 18 on the pawl. The release surface 18 is preferably located on an end of the pawl 13 remote from the tooth 15.

The jaw portions 8, 9 of the handles 2, 3 preferably comprise substantially parallel surfaces for gripping or clamping a workpiece. The jaw portions 8, 9 may also comprise a dented surface for improved gripping of the workpiece.

In use, the jaws 8, 9 of the pliers are first fully opened to the maximum jaw opening width. By squeezing the two handle portions together, the handle portion 5 of the second handle 3 slides along the second end of the spacing means 10 and simultaneously pivots around the second end in a seesaw-like movement. The simultaneous sliding and pivoting of the second handle 3 causes the pawl 13 to move along the notches 12 within the aperture 11 and the jaws 8, 9 automatically self adjust to the required clamping width.

The spacing means 10 serves two specific functions. Firstly, it controls the movement of the pawl 13 within the aperture 11, as explained above. Indeed, the spacing means 10 is used to adjust the movement and positioning of the pawl during the closing action. In addition, the spacing means acts as a pinch guard to prevent the handle portions 4, 5 closing on each other and causing injury to the user.

When the spacing means 10 can be rigid and serve the functions described above. Alternatively, the spacing means 10 can comprise a spring means, such as a helical spring. The spring means has the added advantage that the compression can spread the handle portions 4, 5 apart, thereby helping the user to reopen the pliers with one hand.

When the handle portions 4, 5 are squeezed with one hand to initiate the automatic self adjustment of the opening width of the jaws 8, 9, the tooth 15 fits into the series of notches 12 on the leading edge of the longitudinal slot and locks at the desired position to prevent the jaws inadvertently reopening.

Upon reaching the optimum position, the spring 16 allows for rotation of the pawl 13 in the longitudinal ratcheting aperture 11 for the handles 2, 3 to allow the jaws 8, 9 to exert the maximum required pressure on the material to be clamped without hindrance. When the handle portions 4, 5 are further squeezed, the jaws 8, 9 automatically adjust to the ideal position to allow them to be substantially parallel and exert the maximum pressure whilst employing the largest gripping surface.

The spring 16 within the mechanism ensures that adequate pressure is exerted against the rear edge of the longitudinal slot to prevent the mechanism inadvertently disengaging. In known pliers, the mechanism is not engaged when the jaws are opened and the pawl engages the ratchet when the jaws are closed. However, in the pliers according to the invention, the ratchet 12 and pawl 13 mechanism is engaged when the jaws 8, 9 are opened and when they are closed, and the added pressure to the handle portions 4, 5 serves to close the pliers. Therefore, the pliers according to the invention are easier to handle with one hand than prior pliers.

When the pliers are reopened to allow the jaws 8, 9 to travel back to their maximum opening position, the release pin 17 activates the top of the pawl 13 and tilts it forwards so that the tooth disengages the notches 12. This allows the jaws 8, 9 to be freely adjusted. In other words, the release pin 17 exerts pressure on the release surface 18 of the pawl 13 thereby allowing the pawl 13 to pivot about the pivot pin 14 and release the tooth from the notches 12 in the longitudinal slot 11. At the same time, the spring pressure exerted against the rear edge of longitudinal slot 11 is reduced and the two handle portions 4, 5 can be slid apart to open the jaws 8, 9 to the maximum.

One further advantage of the pliers according to the invention is that it is not necessary to open the jaws 8, 9 to the maximum position to reload the automatic mechanism. The handle portions 4, 5 can be squeezed so that the pawl 13 is at any position within the longitudinal slot 11 and the pliers will automatically readjust and close to the size of the material to be held.

1. A self-adjusting pair of pliers for clamping a workpiece comprising
a first and a second handle, each handle comprising a jaw portion, a neck portion and a handle portion,
a spacing means between the handle portions for adjusting the opening width of the jaw portions; and
wherein the two handles are pivotably and slidably connected to each other by means of releasable locking means.

2. The pair of pliers of claim 1, wherein the spacing means has a first and a second end, the first end being attached to the handle portion of the first handle.

3. The pair of pliers of claim 1 or 2, wherein, when pressure is applied on the handle portion of the second handle, the second handle slides over the second end of the spacing means so that the opening width of the jaws decreases.

4. The pair of pliers of any preceding claim, wherein the spacing means comprises a helical spring.

5. The pair of pliers of any preceding claim, wherein the releasable locking means comprises a longitudinal aperture on the neck portion of the first handle and a pawl pivotably connected to the neck portion of the second handle; and
wherein the longitudinal aperture comprises a plurality of notches and the pawl comprises at least one tooth that is engageable to a notch and the pawl is slidably movable along the aperture.

6. The pair of pliers of claim 5, further comprising biasing means connected to the neck portion of the second handle and wherein the biasing means exerts pressure onto the pawl so that the tooth engages with a notch in the aperture.

7. The pair of pliers of claim 5 or 6, the pliers further comprising a release pin for releasing the tooth from the notch.

8. The pair of pliers of any preceding claim, wherein the jaw portions comprise substantially parallel gripping surfaces.

9. The pair of pliers of any preceding claim, wherein at least one jaw portion comprises a dented surface for gripping the workpiece.

10. A pair of pliers substantially as herein described with reference to the accompanying drawings.
